(19) United States
(12) Patent Application Publication
(10) Pub. No.: US 2008/0137676 A1
(43) Pub. Date: Jun. 12, 2008

(54) BUS/DEVICE/FUNCTION TRANSLATION WITHIN AND ROUTING OF COMMUNICATIONS PACKETS IN A PCI SWITCHED-FABRIC IN A MULTI-HOST ENVIRONMENT ENVIRONMENT UTILIZING A ROOT SWITCH

(76) Inventors: William T Boyd, Poughkeepsie, NY (US); Douglas M. Freimuth, New York, NY (US); William G. Holland, Cary, NC (US); Steven W. Hunter, Raleigh, NC (US); Renato J. Recio, Austin, TX (US); Steven M. Thurber, Austin, TX (US); Madeline Vega, Austin, TX (US)

Correspondence Address: IBM CORP (YA);C/O YEE & ASSOCIATES PC, P.O. BOX 802333, DALLAS, TX, 75380, US

(21) Appl. No.: 11/567,411

(22) Filed: Dec. 6, 2006

(51) Int. Cl. H04L 12/56

(52) U.S. Cl. 370/419

(57) ABSTRACT

A computer-implemented method, apparatus, and computer program product are disclosed for bus/device/function (BDF) translation and routing of communication packets through a fabric that utilizes a single multi-root PCI switch. A data processing environment includes multiple host computer systems that are coupled to and share I/O adapters using a PCI switched-fabric bus fabric. The processing environment includes an apparatus that receives a communications packet, from one of the host computer systems, that is intended to be delivered to a particular one of the adapters. The apparatus analyzes the packet to determine a non-unique host-assigned destination device functional identifier that is included in the packet. The apparatus translates the host-assigned destination device functional identifier into a unique virtual destination device functional identifier. The packet is then routed through the fabric utilizing the virtual destination device functional identifier instead of the host-assigned destination device functional identifier or a destination address of the destination device.

### BACKGROUND OF THE INVENTION

1. Field of the Invention

The present invention relates generally to data processing systems and more particularly to communications in a data processing system including multiple host computer systems and one or more adapters where the host computer systems share the adapter(s) and communicate with those adapter(s) through a PCI switched-fabric bus. Still more specifically, the present invention relates to a computer-implemented method, apparatus, and computer program product for translating bus/device/function numbers and routing communication packets that include those numbers through a PCI switched-fabric that utilizes a single multi-root PCI switch to enable multiple host computer systems to share one or more adapters.

2. Description of the Related Art

A conventional PCI bus is a local parallel bus that permits expansion cards to be installed within a single computer system, such as a server or a personal computer. PCI-compliant adapter cards can then be coupled to the PCI bus in order to add input/output (I/O) devices, such as disk drives, network adapters, or other devices, to the computer system. A PCI bridge/controller is needed in order to connect the PCI bus to the system bus of the computer system. The adapters on the PCI bus can communicate through the PCI bridge/controller with the CPU of the computer system in which the PCI bus is installed. Several PCI bridges may exist within a single computer system. However, these PCI bridges serve to couple multiple PCI buses to the CPU of the computer system in which the PCI buses are installed. If the single computer system includes multiple CPUs, the PCI buses can be utilized by the multiple CPUs of the single computer system.

A PCI Express (PCIe) bus is a recent version of the standard PCI Computer bus. PCIe is based on higher speed serial communications. PCIe is architected specifically with a tree-structured I/O interconnect topology in mind with a Root Complex (RC) denoting the root of an I/O hierarchy that connects a host computer system to the I/O.

PCIe provides a migration path compatible with the PCI software environment. In addition to offering superior bandwidth, performance, and scalability in both bus width and bus frequency, PCI Express offers other advanced features. These features include QoS (quality of service), aggressive power management, native hot-plug, bandwidth per pin efficiency, error reporting, recovery and correction and innovative form factors, peer-to-peer transfers and dynamic reconfiguration. PCI Express also enables low-cost design of products via low pin counts and wires. A 16-lane PCI Express interconnect can provide data transfer rates of 8 Gigabytes per second.

The host computer system typically has a PCI-to-Host bridging function commonly known as the root complex. The root complex bridges between a CPU bus, such as HyperTransport™, or the CPU front side bus (FSB) and the PCI bus. Multiple host computer systems containing one or more root functions are referred to as a multi-root system. Multi-root configurations which share I/O fabrics have not been addressed well in the past.

Today, PCIe buses do not permit sharing of PCI adapters among multiple separate computer systems. Known I/O adapters that comply with the PCIe standard and provide functions or connectivity to a network standard, such as Fibre Channel, InfiniBand, or Ethernet, are typically integrated into blades and server computer systems and are dedicated to the blade or system in which they are integrated. Having dedicated adapters adds to the cost of each system because an adapter is expensive. In addition to the cost issue, there are physical space concerns in a blade system. There is little space available in a blade for one adapter, and generally no simple way to add more than one.

Being able to share adapters among a number of host computers would lower the connectivity cost per host, since each adapter is servicing the I/O requirements of a number of hosts, rather than just one. Being able to share adapters among multiple hosts can also provide additional I/O expansion and flexibility options. Each host could access the I/O through any number of the adapters collectively available. Rather than being limited by the I/O slots in the host system, the I/O connectivity options include the use of adapters installed in any of the host systems connected through the shared bus.

In known systems, the PCIe bus provides a communications path between a single host and the adapter(s). Read and write accesses to the I/O adapters are converted in the root complex to packets that are transmitted from the host computer system, or a system image that is included within that host computer system, through the PCIe fabric to an intended adapter that is assigned to that host or system image. The PCIe standard defines a bus/device/function (BDF) number (B=PCI Bus segment number, D=PCI Device number on that bus, and F=Function number on that specific device) that can be used to identify a particular function within a device, such as an I/O adapter. The host computer system's root complex is responsible for assigning a BDF number to the host and each function within each I/O adapter that is associated with the host.

The BDF number includes three parts for traversing the PCI fabric: the PCI bus number where the I/O adapter is located, the device number of the I/O adapter on that bus, and the function number of the specific function, within that I/O adapter, that is being utilized.

A host may include multiple different system images, or operating system images. A system image is an instance of a general purpose operating system, such as WINDOWS® or LINUX®, or a special purpose operating system, such as an embedded operating system used by a network file system device. When a host includes more than one system image, each system image is treated as a different function within the single device, i.e., the host.

Each communications packet includes a source address field and a destination address field. These are memory addresses that are within the range of addresses allocated to the specific end points. These address ranges correlate to specific source BDF and destination BDF values.

Each packet transmitted by a host includes a destination address which corresponds to the mapped address range of the intended adapter. This destination address is used by the host's root complex to identify the correct output port for this specific packet. The root complex then transmits this packet out of the identified port.

The host is coupled to the I/O adapters using a fabric. One or more switches are included in the fabric. The switches route packets through the fabric to their intended destinations. Switches in the fabric examine the host-assigned adapter BDF to determine if the packet must be routed through the switch, and if so, through which output switch port.

According to the PCIe standard, the root complex within a host assigns BDF numbers for the host and for the adapters. The prior art assumes that only one host is coupled to the fabric. When only one host is coupled to the fabric, there can be no overlap of BDF numbers the root complex assigns since the single root complex is responsible for assigning all BDF numbers. If there is no overlap, switches are able to properly route packets to their intended destinations.

A root complex follows a defined process for assigning BDF numbers. The root complex assigns a BDF number of 0.0.1 to a first system image, a BDF number of 0.0.2 to a second system image, and so on.

A physical I/O adapter may be able to provide one or more functions on behalf of multiple system images. Such virtualized adapters are typically virtualized such that a physical I/O adapter appears as multiple separate virtual I/O adapters. Each one of these virtual adapters is a separate function. The number of virtual adapters that can be provided from a physical adapter is determined by the design of the adapter.

Each virtual I/O adapter is associated with a system image. One physical I/O adapter that supports virtualization can be virtualized into virtual I/O adapters, each of which can be associated with different system images. For example, if the host includes three system images, a physical I/O adapter that can be virtualized into three virtual I/O adapters can provide a virtual I/O adapter associated with each of the three different system images. Further, a system could include several physical I/O adapters, each providing one or more virtual adapters. The virtual I/O adapters would then be associated with the different system images of the single host. For example, a first physical I/O adapter might include a first virtual I/O adapter that is associated with a first system image of the host and a second virtual I/O adapter that is associated with a second system image of the host. A second physical adapter might include only a single virtual I/O adapter that is associated with a third system image of the host. A third physical adapter might include two virtual adapters, the first associated with the second system image and the second associated with the third system image.

If multiple hosts are simultaneously coupled to the fabric, there will be overlap of the BDF numbers that are selected by the root complexes of the hosts. Overlap occurs because each host will assign a BDF number of 0.0.1 to itself. Thus, a BDF that should identify only one function included in only one host will not uniquely identify just one function in just one host.

The root complex assigns a BDF number of 1.1.1 to the first function within a first adapter that the root complex sees on a first bus. This process continues until all BDF numbers are assigned.

Unique memory address ranges are assigned to each device as needed for that device to operate. These address ranges correspond to the assigned BDF numbers, but only the root complex maintains a table of the corresponding values, which it uses to route packets.

If multiple hosts are coupled to the fabric, each host's root complex will assign a BDF number of 1.1.1 to the first function within a first adapter that a root complex sees on a first bus. This results in the BDF number 1.1.1 being assigned to multiple different functions. Therefore, there is overlap of BDF numbers that would be used by the multiple hosts.

In a similar fashion, the memory address ranges assigned on each host for its devices will overlap with the memory address ranges assigned on other hosts to their devices. When the BDF numbers overlap and memory address ranges overlap, switches are unable to properly route packets.

Therefore, a need exists for a method, apparatus, and computer program product for address translation and routing of communication packets through a fabric that includes one or more host systems, each of which having one or more system images, communicating with one or more physical adapters, each of which providing one or more virtual adapters, through only one multi-root switch.

### SUMMARY OF THE INVENTION

The preferred embodiment of the present invention is a computer-implemented method, apparatus, and computer program product for translation of addresses and improved routing of communication packets through a PCI switched-fabric that utilizes only one multi-root PCI switch.

A computer-implemented method, apparatus, and computer program product are disclosed for translating addresses and routing of communication packets through the fabric that utilizes a single multi-root PCI switch with or without additional PCI switches and/or PCI bridges. A data processing environment includes host computer systems that are coupled to adapters using a PCI bus or multiple PCI bus segments interconnected with PCI switches into a single PCI fabric. The fabric includes a mechanism that receives a communications packet, from one of the host computer systems, that is intended to be delivered to a particular function that is provided by one of the adapters.

The mechanism analyzes the packet to determine which function the packet is destined for. The source address and destination address in the packet uniquely identify a specific host-function pair. The destination address written in the packet by the host system includes the host-assigned adapter BDF number that identifies a particular function, encoded into the address. This host-assigned adapter BDF is replaced, by the mechanism, with a virtual adapter BDF that identifies the intended function in the adapter.

The source address in the packet is the host-assigned address that identifies the function in the host that generated the packet, the host assigned host BDF number corresponding to this function is encoded into the source address. The host-assigned host BDF is replaced, by the mechanism, with a virtual host BDF.

The virtual BDF numbers are unique and cannot be duplicated within the fabric.

The mechanism then transmits the packet to the next device in the fabric, which is typically another switch in the fabric. The packet is routed within the fabric, once transmitted out of the mechanism, using the virtual BDF numbers, instead of the host-assigned BDF numbers.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a diagram of a distributed computer system in accordance with the illustrative embodiment;

FIG. 2 is a block diagram of a logically partitioned platform in accordance with the illustrative embodiment;

FIG. 3 is a block diagram of a data processing system, which includes a PCI switched-fabric bus (the fabric), that includes a BDF translation mechanism implemented in a single multi-root PCI switch to which all of the host systems are directly connected in accordance with the illustrative embodiment;

FIG. 4 illustrates a block diagram of the fields that make up a communications packet in accordance with the illustrative embodiment;

FIG. 5 is a block diagram of a BDF translation table in accordance with the illustrative embodiment;

FIG. 6 is a high level flow chart that depicts a mechanism in a multi-root switch receiving a packet from a particular host that is destined for a particular function within an adapter and translating the host-assigned BDF values that are included in the packet into virtual BDF values that will be used for further routing of the packet in accordance with the illustrative embodiment;

FIG. 7 is a high level flow chart that depicts a mechanism in a multi-root switch receiving a packet, from an adapter, that is destined for a particular host and translating the virtual BDF numbers that are included in the packet into host-assigned BDF numbers that will be used for further routing of the packet in accordance with the illustrative embodiment; and

FIG. 8 illustrates a high level flow chart that depicts a non-root PCI switch routing a packet using the virtual BDF numbers using standard packet handling in accordance with the illustrative embodiment.

### DETAILED DESCRIPTION OF THE PREFERRED EMBODIMENT

The illustrative embodiment can be implemented in any general or special purpose computing system where multiple host computer systems share a pool of I/O adapters (IOAs) through a common I/O fabric. In the illustrative embodiment, the fabric is a collection of devices that conform to the PCI Express standard.

In the illustrative embodiment, the I/O fabric is attached to more than one host computer system such that multiple different host computer systems can share the I/O adapters, which are also attached to the fabric, with other host computer systems. The adapters may be either physical adapters that provide a single function, or physical adapters that have been divided into multiple functions, where each one of the functions is represented as a virtual adapter. Preferably, each physical adapter, function, or virtual adapter has been allocated to one and only one particular host computer system.

Host computer systems access each fabric device and/or adapter it is authorized to access using a host-assigned BDF number. The host-assigned BDF numbers that are assigned by a host are unique within the scope of that particular host. Thus, there is no duplication within a particular host of any host-assigned BDF numbers. Since each host assigns its own BDF numbers, however, the same BDF numbers may be assigned by other hosts to the adapters that they are authorized to use. Although host-assigned BDF numbers are unique within a particular host, they may not be unique across all hosts or across the entire fabric.

When a host transmits a packet to one of its assigned adapters, the host inserts its host-assigned adapter BDF number of the intended adapter into the destination BDF field that is included in the packet. The host places the host's own host-assigned host BDF number into the source BDF field that is included in the packet.

According to the illustrative embodiment, a translation mechanism (the BDF table) is included within a single multi-root PCI switch in the system's fabric. The system includes one and only one multi-root PCI switch. The multi-root PCI switch is the PCI switch that is directly connected to the hosts with no intervening devices.

The BDF table is preferably a hardware device. The BDF table is used to enable or disable access from each host to each device, simplify routing of communications between hosts and devices, and to protect the address space of one host from another host.

The BDF table includes information that associates each particular host's host-assigned adapter BDF number for each virtual adapter to the virtual adapter BDF number for that same virtual adapter. When a packet is received by the multi-root PCI switch from a host, the multi-root PCI switch moves the packet into the BDF table. A mechanism within the BDF table analyzes the host-assigned adapter BDF value that is included in the destination BDF field of the packet. The mechanism uses the host-assigned host BDF number that is included in the source BDF field of the packet to identify which host issued the packet. Optionally, in simple configurations, it may be possible to uniquely identify the specific host just by identifying the port through which the root PCI switch received the packet. This source information (host identification) along with the destination information (host-assigned adapter BDF number) is used to identify the virtual adapter BDF number for the virtual adapter to which this packet is to be transmitted.

The mechanism in the BDF table then modifies the packet by replacing the values in the source and destination BDF fields in the packet. The mechanism replaces the destination host-assigned adapter BDF number of the intended destination virtual adapter with the virtual adapter BDF value of that virtual adapter. The mechanism replaces the source host's host-assigned host BDF number with the virtual host BDF number that identifies that source host.

The root PCI switch then moves the packet out of the BDF table and through the appropriate one of the root PCI switch's ports based on the updated destination BDF in the packet. The packet is then routed throughout the rest of the fabric using the virtual BDF numbers that are now stored in the packet.

The virtual BDF numbers uniquely identify a particular function that is included within either a host or an I/O adapter. Multiple hosts can share adapters because unique virtual BDF numbers are assigned to each function in the system. Packets that include the virtual BDF numbers, instead of the host-assigned non-unique BDF numbers, can be properly routed to the intended functions. The illustrative embodiment is a method, apparatus, and product for replacing the host-assigned BDF numbers with the appropriate virtual BDF numbers.

Further, the illustrative embodiment describes replacing the host-assigned BDF numbers with virtual BDF numbers using a BDF table that is included in the multi-root switch. Since packets that are routed out of the multi-root switch downstream (away from the hosts and toward the adapters) already include the virtual BDF numbers, switches downstream of the multi-root switch do not need to translate any BDF numbers from host-assigned to virtual BDF numbers or from virtual to host-assigned BDF numbers. Therefore, the non-root switches merely need to read the destination field and route the packet to the device that is identified by the virtual BDF number that is stored in that field.

The mechanism required to enable multi-host configurations is completely contained within the BDF table in the single root switch. The non-root switches in the fabric do not require any special hardware, and they do not need to participate in the BDF translation.

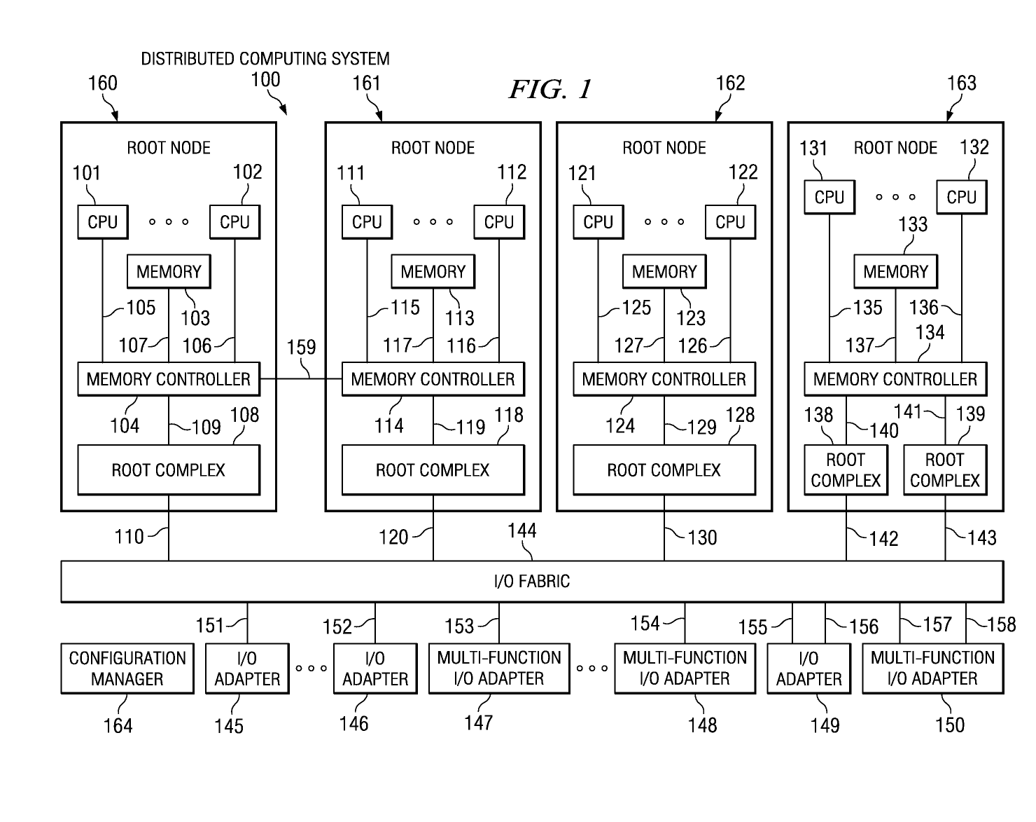

With reference now to the figures and in particular with reference to FIG. 1, a diagram of a distributed computing system environment 100 is illustrated in accordance with the illustrative embodiment. The distributed computer system represented in FIG. 1 takes the form of two or more root complexes (RCs) 108, 118, 128, 138, and 139, attached to an I/O fabric 144 through I/O links 110, 120, 130, 142, and 143, and to the memory controllers 104, 114, 124, and 134 of the root nodes (RNs) 160-163.

A root complex is included within each host in a root node. The host computer system typically has a PCI-to-Host bridging function commonly known as the root complex. The root complex bridges between a CPU's Front Side Bus (FSB), or another CPU bus, such as hyper-transport, and the PCI bus. A multi-root system is a system that includes two or more hosts, such that two or more root complexes are included. A root node is a complete computer system, such as a server computer system. A root node is also referred to herein as a host node.

In other embodiments, a root node may have a more complex attachment to the fabric through multiple bridges, or connections to multiple points in the fabric. Or, a root node may have external means of coordinating the use of shared adapters with other root nodes. But, in all cases, the BDF table described in this invention is located between the host system(s) and the adapter(s), so that it can intervene on all communications between hosts and adapters. The BDF table will treat each host-function pair as a single connection, with just one entry port and just one exit port in the root switch.

The I/O fabric is attached to the IOAs 145-150 through links 151-158. The IOAs may be single function IOAs as in 145-146 and 149, or multiple function IOAs as in 147-148 and 150. Further, the IOAs may be connected to the I/O fabric via single links as in 145-148 or with multiple links for redundancy, performance, or other reasons as in 149-150.

The root complexes (RCs) 108, 118, 128, 138, and 139 are each part of a root node (RN) 160-163. There may be more than one root complex per root node as in RN 163. In addition to the root complexes, each root node consists of one or more Central Processing Units (CPUS) or other processing elements 101-102, 111-112, 121-122, 131-132, memory 103, 113, 123, and 133, a memory controller 104, 114, 124, and 134 which connects the CPUS, memory, and I/O through the root complex and performs such functions as handling the coherency traffic for the memory.

Root nodes may be connected together, such as by connection 159, at their memory controllers to form one coherency domain which may act as a single Symmetric Multi-Processing (SMP) system, or may be independent nodes with separate coherency domains as in RNs 162-163.

Configuration manager 164 is also referred to herein as a PCI manager. Alternatively, the PCI manager 164 may be a separate entity connected to the I/O fabric 144, or may be part of one of the RNs 160-163.

Distributed computing system 100 may be implemented using various commercially available computer systems. For example, distributed computing system 100 may be implemented using an IBM eServer iSeries Model 840 system available from International Business Machines Corporation. Such a system may support logical partitioning using an OS/400 operating system, which is also available from International Business Machines Corporation.

Those of ordinary skill in the art will appreciate that the hardware depicted in FIG. 1 may vary. For example, other peripheral devices, such as optical disk drives and the like, also may be used in addition to or in place of the hardware depicted. The depicted example is not meant to imply architectural limitations with respect to the present invention.

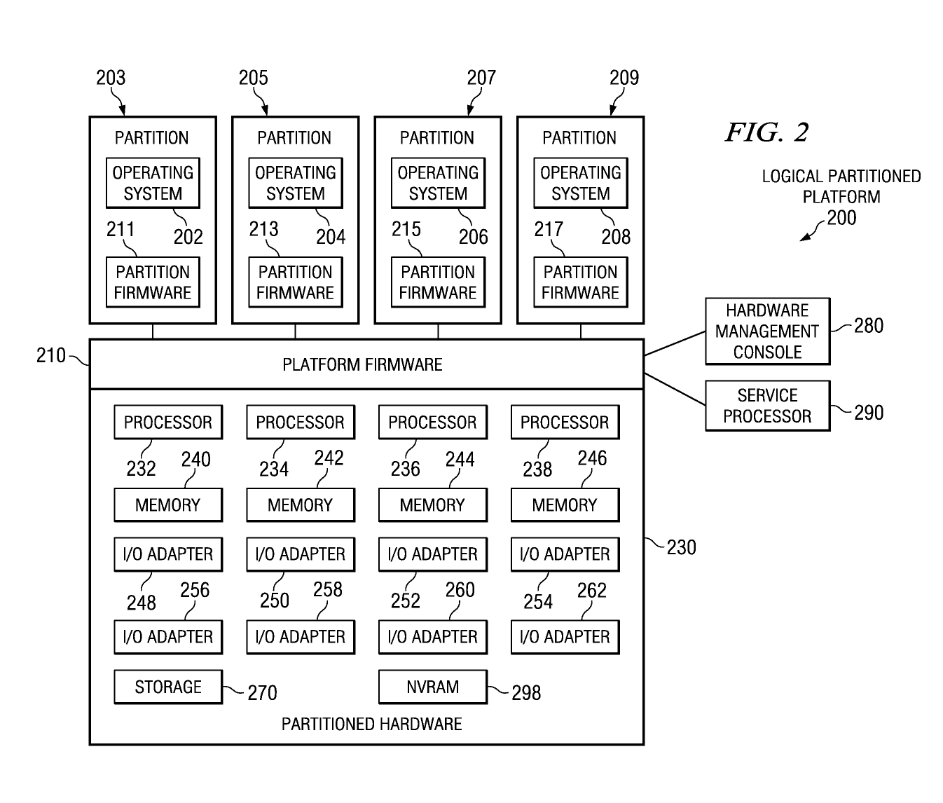

FIG. 2 is a block diagram of a logically partitioned platform in accordance with the illustrative embodiment. The hardware in logically partitioned platform 200 may be implemented as, for example, distributed computing system 100 in FIG. 1. Logically partitioned platform 200 includes partitioned hardware 230, operating systems 202, 204, 206, 208, and partition management firmware 210.

Operating systems 202, 204, 206, and 208 may be multiple copies of a single operating system or multiple heterogeneous operating systems simultaneously run on logically partitioned platform 200. These operating systems may be implemented using OS/400, which is designed to interface with partition management firmware, such as Hypervisor. OS/400 is used only as an example in these illustrative embodiments. Other types of operating systems, such as AIX and Linux, may also be used depending on the particular implementation.

Operating systems 202, 204, 206, and 208 are located in partitions 203, 205, 207, and 209. Hypervisor software is an example of software that may be used to implement partition management firmware 210 and is available from International Business Machines Corporation. Firmware is “software” stored in a memory chip that holds its content without electrical power, such as, for example, read-only memory (ROM), programmable ROM (PROM), erasable programmable ROM (EPROM), electrically erasable programmable ROM (EEPROM), and nonvolatile random access memory (nonvolatile RAM).

Additionally, these partitions also include partition firmware 211, 213, 215, and 217. Partition firmware 211, 213, 215, and 217 may be implemented using initial boot strap code, IEEE-1275 Standard Open Firmware, and runtime abstraction software (RTAS), which is available from International Business Machines Corporation.

When partitions 203, 205, 207, and 209 are instantiated, a copy of boot strap code is loaded onto partitions 203, 205, 207, and 209 by platform firmware 210. Thereafter, control is transferred to the boot strap code with the boot strap code then loading the open firmware and RTAS. The processors associated or assigned to the partitions are then dispatched to the partition's memory to execute the partition firmware.

Partitioned hardware 230 includes a plurality of processors 232, 234, 236, and 238, a plurality of system memory units 240, 242, 244, and 246, a plurality of I/O Adapters (IOAs) 248, 250, 252, 254, 256, 258, 260 and 262, an NVRAM storage 298, and a storage unit 270. Each of the processors 232, 234, 236, and 238, memory units 240, 242, 244, and 246, NVRAM storage 298, and IOAs 248, 250, 252, 254, 256, 258, 260 and 262, or parts thereof, may be partitioned to one of multiple partitions within logical partitioned platform 200 by being assigned to one of the partitions, each of the partitioned resources then corresponding to one of operating systems 202, 204, 206, and 208.

Partition management firmware 210 performs a number of functions and services for partitions 203, 205, 207, and 209 to create and enforce the partitioning of logically partitioned platform 200. Partition management firmware 210 is a firmware implemented virtual machine identical to the underlying hardware. Thus, partition management firmware 210 allows the simultaneous execution of independent OS images 202, 204, 206, and 208 by virtualizing the hardware resources of logical partitioned platform 200.

Service processor 290 may be used to provide various services, such as processing of platform errors in the partitions. These services also may act as a service agent to report errors back to a vendor, such as International Business Machines Corporation. Operations of the different partitions may be controlled through a hardware management console, such as hardware management console 280. Hardware management console 280 is a separate distributed computing system from which a system administrator may perform various functions including reallocation of resources to different partitions.

In a logically partitioned (LPAR) environment, it is not permissible for resources or programs in one partition to affect operations in another partition. Furthermore, to be useful, the assignment of resources needs to be fine-grained.

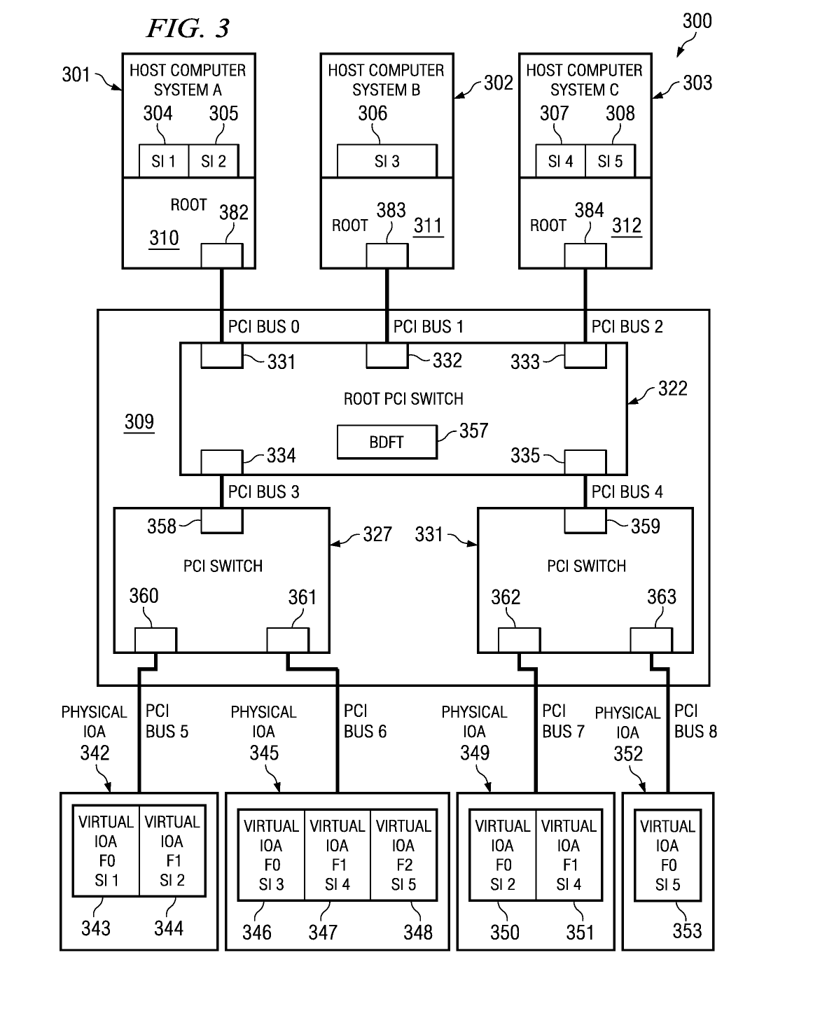

FIG. 3 illustrates a data processing system, which includes a PCI switched-fabric bus that includes BDF number translation and routing in accordance with the illustrative embodiment. FIG. 3 depicts a PCI fabric that supports multiple root nodes through a single root PCI switch.

Data processing system 300 includes a plurality of host computer systems 301-303, each containing a single or plurality of system images (SIs) 304-308. These systems then interface to the I/O fabric 309 through their root complexes 310-312. Each of these root complexes can have one port connected to the PCI root switch. Root complex 310 is connected to port 331 of PCI switch 322 through port 382. Root complex 311 is connected to port 332 of PCI switch 322 through port 383. Root complex 312 is connected to port 333 of PCI switch 322 through port 384. The connection from the root complex port to the PCI root switch port can be made with one or more physical links that are treated as a single port to port connection. A host computer system along with the corresponding root complex is referred to as a root node.

Each root node is connected to a port of a multi-root aware switch 322. This is called the PCI root switch. A multi-root aware switch, in the preferred embodiment, includes the configuration mechanisms that are necessary to discover and configure a multi-root PCI fabric. The PCI configuration manager can use mechanisms provided in the PCI root switch to enumerate all of the devices on the PCI fabric and all of the hosts connected to the PCI root switch. The PCI configuration manager will then provide the PCI fabric topology information and the host to function access permissions to the PCI root switch.

The ports of a multi-root aware switch, such as 322, can be used as upstream ports, downstream ports, or upstream and downstream ports, where the definition of upstream and downstream is as described in PCI Express Specifications. In FIG. 3, ports 331, 332, and 333, are upstream ports. Ports 360, 361, 362, and 363 are downstream ports, and ports 334, 335, 358, and 359 are upstream/downstream ports.

The ports configured as downstream ports are used to attach adapters to the PCI fabric or to connect to the upstream port of another switch. In FIG. 3, PCI switch 327 uses downstream port 360 to attach physical I/O Adapter (IOA) 342 to the PCI fabric via PCI bus 5. Physical adapter 342 has two virtual IO adapters, or virtual I/O resources, 343 and 344. Virtual adapter 343 is function 0 (F0) of physical adapter 342, and virtual adapter 344 is function 1 (F1) of physical adapter 342.

Similarly, PCI switch 327 uses downstream port 361 to attach physical I/O Adapter 345 to the PCI fabric via PCI bus 6. Physical adapter 345 has three virtual I/O adapters, or virtual IO resources, 346, 347, and 348. Virtual adapter 346 is function 0 (F0) of physical adapter 345. Virtual adapter 347 is function 1 (F1) of physical adapter 345. Virtual adapter 348 is function 2 (F2) of physical adapter 345.

PCI switch 331 uses downstream port 362 to attach physical I/O Adapter 349 to the PCI fabric via PCI bus 7. Physical adapter 349 has two virtual I/O adapters, virtual adapter 350, which is function 0, and virtual adapter 351 which is function 1 of physical adapter 349.

PCI switch 331 uses downstream port 363 to attach a single function physical IOA 352 via PCI bus 8. Physical adapter 352 is shown in this example as a virtualization aware physical adapter that provides a single function, function 0 (F0), to the PCI fabric as virtual adapter 353. Alternately, a non-virtualization aware single function adapter would be attached in the same manner.

The ports configured as upstream ports are used to attach a root complex. In FIG. 3, multi-root aware switch 322 uses upstream port 331 to attach port 382 of root 310 via PCI bus 0, port 332 to attach a port 383 of root 311 via PCI bus 1, and port 333 to attach port 384 of root 312 via PCI bus 2.

The ports configured as upstream/downstream ports are used to attach to the upstream/downstream ports of another switch. In FIG. 3, PCI switch 327 uses upstream/downstream port 358 to attach to upstream/downstream port 334 of multi-root aware switch 322 via PCI bus 3. Multi-root aware switch 322 uses port 335 to attach to port 359 of switch 331 via PCI bus 4.

IOA 342 is shown as a virtualized IOA with its function 0 (F0) 343 assigned and accessible to system image 1 (SI1) 304, and its function 1 (F1) 344 assigned and accessible to system image 2 (SI2) 305. Thus, virtual adapter 343 is partitioned to and should be accessed only by system image 304. Virtual adapter 344 is partitioned to and should be accessed only by system image 305.

In a similar manner, IOA 345 is shown as a virtualized IOA with its function 0 (F0) 346 assigned and accessible to system image 3 (SI3) 306, its function 1 (F1) 347 assigned and accessible to system image 4 (SI4) 307, and its function 2 (F2) 348 assigned to system image 5 (SI5) 308. Thus, virtual adapter 346 is partitioned to and should be accessed only by system image 306; virtual adapter 347 is partitioned to and should be accessed only by system image 307; virtual adapter 348 is partitioned to and should be accessed only by system image 308.

IOA 349 is shown as a virtualized IOA with its F0 350 assigned and accessible to SI2 305, and its F1351 assigned and accessible to SI4 307. Thus, virtual adapter 350 is partitioned to and should be accessed only by system image 305; virtual adapter 351 is partitioned to and should be accessed only by system image 307.

Physical IOA 352 is shown as a single function virtual IOA 353 assigned and accessible to SI5 308. Thus, virtual adapter 353 is partitioned to and should be accessed only by system image 308.

The BDF table in the PCI fabric receives communications packets, translates the destination functional identifier and the source functional identifier within the packet, referred to herein as a Bus/Device/Function (BDF number), modifies the packet by replacing within the packet the original identifiers with the translated identifiers, and forwards the modified packet to the next device in the fabric towards the intended destination.

According to the illustrative embodiment, system 300 includes only one PCI root switch. A PCI root switch is a PCI switch that is connected directly to each of the host computer systems with no other hosts sharing a specific port on the PCI root switch. Thus, each host includes a port that is connected directly to one of the ports included within the root PCI switch. For example, port 382 of host 301 is connected directly to port 331 of root PCI switch 322. Port 383 of host 302 is connected directly to port 332 of root PCI switch 322. Port 384 of host 303 is connected directly to port 333 of root PCI switch 322. All host accesses to PCI fabric-attached devices must pass through the PCI root switch 322.

A PCI root switch may be connected in the fabric to other devices downstream, such as other PCI switches, or adapters. According to the example depicted by FIG. 3, root PCI switch 322 is connected to other PCI switches, i.e. PCI switches 327 and 331. Because PCI switches 327 and 331 are not connected directly to one of the hosts, they are not root PCI switches.

According to the illustrative embodiment, only one BDF table is included in system 300 and it is included within only the root PCI switch. Thus, as depicted by FIG. 3, BDF table 357 is included within root PCI switch 322. Because there is only one BDF table within system 300, no synchronization of BDF table data is needed. The root PCI switch includes the BDF table which in turn includes the mechanism that includes all of the translation and routing information that is needed to perform the necessary translation and routing between the hosts and the adapters.

BDF table 357 includes a table, such as the example depicted by FIG. 5, that is used by the mechanism included in BDF table 357 to perform lookup and translations and modifications of packets. This mechanism can be implemented in either hardware or software so long as it performs the processes described herein.

BDF table 357 can be implemented using any suitable hardware. For example, BDF table 357 may be implemented as a single array in which the table of FIG. 5 is stored, or BDF table 357 may be implemented as a group of separate registers where each register is associated with only one particular virtual adapter and stores the information for only its associated virtual adapter.

Alternatively, a group of registers may be used to implement BDF table 357 where each register is associated with a particular one of the root PCI switch's ports. Thus, if there are five ports, such as depicted by FIG. 3, there will be five registers that together make up BDF table 357.

When root PCI switch 322 receives a packet, root PCI switch 322 moves the packet into BDF table 357 where the mechanism performs a lookup, translation, and modification of the packet. Once the mechanism has finished this lookup, translation, and modification process, root PCI switch 322 moves the packet out of BDF table 357 and out the appropriate egress port of root PCI switch 322.

System 300 is partitioned such that each system image in each host is permitted to access only those adapters that are allocated, i.e., partitioned, to that particular system image. This partitioning is managed by the PCI configuration manager.

The BDF table is used to allow authorized communications between hosts and adapters, and to enforce the partitioning of the system, preventing unauthorized communications. The BDF table includes a table row for each virtual adapter. A virtual adapter's row includes, at a minimum, a unique designation of the host that this adapter is allocated to (host-assigned host BDF plus the host port number), a designation used to refer to this specific host that is fabric-wide unique (virtual host BDF), a host-specific designation used by this host to address this specific adapter (host-assigned adapter BDF), a fabric-wide unique designation for this adapter (virtual adapter BDF), and an indication that this adapter is allocated to this host. The BDF table may include additional identifiers to assist in the translation of data packets from the hosts to the adapters and from the adapters to the hosts, or additional control information to allow more finely grained control over the specific types of communications allowed, or how and when that communication may take place.

The mechanism in the BDF table receives a packet, translates the host-assigned host BDF into the appropriate virtual host BDF, and translates the host-assigned adapter BDF into the appropriate virtual adapter BDF using the information in the BDF table. Then, the packet is routed on toward the intended adapter using the virtual adapter BDF. In this manner, the mechanism in the BDF table provides additional protection among partitions because the mechanism routes packets to only those virtual adapter BDFs that are found to be allowed in the appropriate row in the BDF table. The virtual adapter BDF uniquely identifies the virtual adapter.

When the adapter sends a packet to the host, it places the virtual host BDF in the destination address, and places the adapter's own virtual adapter BDF in the source address. Using the virtual host BDF, the PCI switches in the fabric will route the packet to the PCI root switch for translation by the mechanism in the BDF table. The BDF table translation is reversed, so that the virtual host BDF is replaced with the host-assigned host BDF, and the virtual adapter BDF is replaced with the host-assigned adapter BDF. As with the host-to-adapter packet, the adapter-to-host packet can also be allowed or denied based on the permission control bits in the BDF table for this host-adapter pair. The host port number is used to select the upstream port through which this packet will be sent.

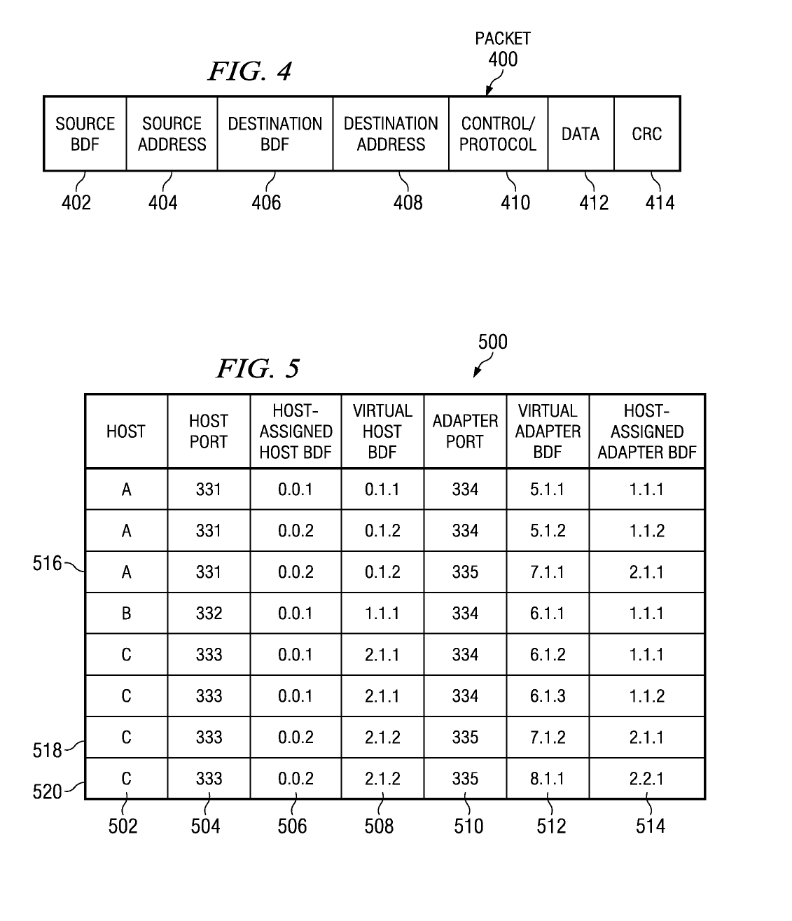

FIG. 4 is a block diagram that depicts a communications packet in accordance with the illustrative embodiment. Communications packet 400 preferably conforms to the PCI Express (PCIe) standard. This packet structure 400 is used by hosts and I/O adapters to communicate with each other. Packet 400 includes a source BDF field 402 for storing the BDF number of the sender of the packet, a source address field 404 for storing the specific address within the sender of the packet, a destination BDF field 406 for storing the destination BDF of the intended recipient of the packet, a destination address field 408 for storing the specific address within the intended recipient of the packet, a control/protocol field 410 for storing control information, a data field 412 for storing data, and a field 414 for storing error correcting bits. The error correcting bits can be a CRC or any other error correcting code. All but the source BDF and destination BDF fields are optional and not required for the translations described here.

When a host transmits a packet to an adapter, the host stores the host-assigned adapter BDF number of the intended destination virtual adapter in destination BDF 406 and stores the host's host-assigned host BDF in source BDF field 402. When an adapter transmits a packet to a host, the adapter stores the virtual host BDF number of the intended host in destination BDF 406 and stores the adapter's virtual adapter BDF in source BDF field 402.

FIG. 5 is a block diagram of a BDF translation and protection table in accordance with the illustrative embodiment. Table 500 includes a separate row for each host-virtual adapter pair. For example, in the embodiment depicted in FIG. 3, there are four physical adapters presented as eight virtual adapters. Each virtual adapter is allocated to one of the system images of the hosts. Therefore, there is a separate row in table 500 for each one of these host-allocated virtual adapters.

Each row in table 500 includes at least a field for a host-assigned host bus/device/function BDF, a host-assigned adapter (BDF) number, a fabric-wide unique virtual adapter BDF, and a fabric-wide unique virtual host BDF; these combinations uniquely identify a host-adapter pair. Each row may also include an adapter port, and a host port. Table 500 includes values in a host field 502, a host port field 504, a host-assigned host BDF field 506, a virtual host BDF field 508, an adapter port field 510, a virtual adapter BDF field 512, and a host-assigned adapter BDF field 514.

The BDF number that a host has assigned to one of its system images is stored in field 506. The BDF number that the host has assigned to a particular virtual adapter is stored in field 514. The fabric-wide unique virtual BDF number that is assigned to a particular system image in a particular host is stored in field 508; the fabric-wide unique virtual BDF number that is assigned to a particular virtual adapter is stored in field 512.

For example, host 301 has assigned a host-assigned BDF of 0.0.1 to system image 304 and 0.0.2 to system image 305. Host 301 has assigned a host-assigned BDF of 1.1.1 to virtual adapter 343, 1.1.2 to virtual adapter 344, and 2.1.1 to virtual adapter 350.

At initialization time when system 300 is initialized, the BDF table will be populated with the appropriate data. The PCI configuration manager populates columns 508 and 512 with the appropriate data. Although the PCI configuration manager 164 is described as populating the table with data, those skilled in the art will recognize that other devices and/or routines may be used to populate the table. Once the BDF table is populated, the same or a different device and/or routine may be used to manage the data in the BDF table as changes are needed.

The PCI configuration manager has assigned a virtual host BDF of 0.1.1 to system image 304 and 0.1.2 to system image 305. When PCI switch 322 receives a packet, such as packet 400, from a host, the packet is received through port 331, 332, or 333. This packet is then routed to BDF table 357 by PCI switch 322. The mechanism within BDF table 357 then analyzes the value that is included in the destination BDF field 406 of packet 400. The value that is included in field 406 is the host-assigned BDF number of the adapter for which this packet is intended to be transmitted. This is the host-assigned adapter BDF that was inserted into the packet by the transmitting host.

For example, system image 305 in host 301 may intend to transmit a packet to its virtual adapter 350. In this example, host 301 has assigned a host-assigned BDF of 0.0.2 to system image 2 and assigned a host-assigned adapter BDF of 7.1.1 to virtual adapter 350. Host 301 will transmit this packet to root PCI switch 322 through its root bridge 310 via port 382 across PCI bus 0 to port 331 of root PCI switch 322. This packet will include a host-assigned adapter BDF of 2.1.1 in the destination BDF field of the packet. When PCI switch 322 receives the packet, PCI switch 322 will move the packet into BDF table 357. The mechanism within BDF table 357 will then use the host port number through which this packet was received as well as the host-assigned adapter BDF number that is included in the packet to identify the entry that is associated with this virtual adapter. For example, the packet of this example arrived via host port 331 and includes a host-assigned adapter BDF number of 2.1.1 in its destination address BDF field. Therefore, row 516 is associated with virtual adapter 350. The mechanism in BDF table 357 then looks up the virtual adapter BDF number from row 516. This virtual adapter BDF number, i.e. 7.1.1, is read from the virtual adapter BDF column 512. The mechanism in BDF table 357 then replaces the host-assigned adapter BDF number that was originally included in the destination BDF field 406 with the virtual adapter BDF number determined from row 516. Thus, host-assigned adapter BDF 2.1.1 is replaced with virtual adapter BDF 7.1.1. Packet 400 now includes the value 7.1.1 in destination BDF field 406.

Before transmitting the packet, host 301 also inserted its own host-assigned host BDF, i.e. 0.0.2, in the source BDF field 402. The mechanism in BDF table 357 performs a lookup to read the virtual host BDF from row 516, which is 0.1.2, and then places that value into the source BDF field 402 of the packet.

PCI switch 322 then routes the translated packet with the modified source and destination BDF values out of PCI switch 322 and into the PCI fabric. Optionally, the PCI root switch 322 can direct the packet through the specific switch port 335 that is read from the adapter port field 510 in row 516. This can save PCI switch 322 from having to route the outbound packet based on additional lookups of the source and destination addresses in the packet. In this example, the packet would be transmitted through port 335.

This packet is then received by either the next switch in the fabric, if there is one, or is received by the intended destination adapter. The packet is routed through additional PCI switches after being moved out of root PCI switch 322 using the value that is stored in destination BDF field 406. According to the illustrative embodiment, the value that is stored in field 406 is the virtual adapter BDF number of the intended recipient of the packet.

For example, once the packet is moved out of root PCI switch 322 through port 335, PCI switch 331 will receive the packet through port 359. PCI switch 331 will then determine where to route the packet using the destination BDF value that is included in field 406 of the packet. This field now contains the virtual adapter BDF value, 7.1.1, which indicates the intended destination virtual adapter 350.

The process described above operates in a similar manner when a packet is transmitted from a virtual adapter to a particular host. For example, virtual adapter 353 may transmit a packet to system image 5 (SI5) 308 in host C 303. In this example, host C 303 had assigned to system image 5 a host-assigned host BDF of 0.0.2 and had assigned a host-assigned adapter BDF of 2.2.1 to virtual adapter 353.

In this example, virtual adapter 353 will transmit the packet to PCI switch 331 through port 363. This packet will include the virtual host BDF value in the destination BDF field 406. In this example, the virtual host BDF value is 2.1.2. The packet will include the virtual adapter BDF of 8.1.1 in the source BDF field 402.

This packet is then routed through PCI switch 331 toward PCI bus 2, as indicated by the BDF of 2.1.2, out port 359, across PCI bus 4, in port 335 of PCI root switch 322 where it is moved to BDF table 357 by PCI switch 322. The mechanism in BDF table 357 then analyzes the value that is included in destination BDF field 406 of packet 400. The value that is included in field 406 is the virtual host BDF number, indicating the particular system image in a host for which this packet is intended to be delivered. For example, system image 308 in host 303 is the intended destination for packets transmitted from virtual adapter 353. So, the virtual host BDF 2.1.2 is in the destination BDF field 406 of packet 400, when sent from virtual adapter 353.

When PCI switch 322 receives the packet, PCI switch 322 will move the packet into BDF table 357. BDF table 357 will use the virtual host BDF number and the virtual device BDF number to identify the table entry that is associated with the intended host-adapter pair. These numbers are read from the packet 400 destination BDF field 406, and source BDF field 402. The packet of this example has a source BDF number 402 of 8.1.1, and a destination BDF number 406 of 2.1.2. In this example the destination BDF field contains the virtual host BDF, and the source BDF field contains the virtual adapter BDF. Therefore, row 520 is associated with the host-adapter pair encompassing system image 308 and virtual adapter 353. Alternately, BDF table 357 could use the source BDF to lookup the host-assigned adapter BDF in the table. Additional checking could be provided by verifying that the packet was received on the correct port of the PCIe root switch.

Once the proper row is identified, the mechanism in BDF table 357 then reads the host-assigned host BDF number from column 506 for the host indicated in row 520. This host-assigned host BDF number read is 0.0.2. The mechanism in BDF table 357 then replaces the virtual host BDF number that was originally included in the destination BDF field 406 with the host-assigned host BDF number determined from row 520. Thus, virtual host BDF 2.1.2 is replaced with host-assigned host BDF number 0.0.2. Packet 400 now includes the value 0.0.2 in field 406. The host-assigned adapter BDF of 2.2.1 is read from the table and stored in source BDF field 402 in place of the virtual adapter BDF that was originally stored in field 402 by the adapter. PCI switch 322 then moves the packet with the modified source and destination BDF values out of PCI switch 322 through host port 333, as indicated by column 504 of row 520. Since host-assigned host BDF values are not unique across the entire PCI fabric, the host port is most efficiently identified during the source destination address translation process in the BDF table.

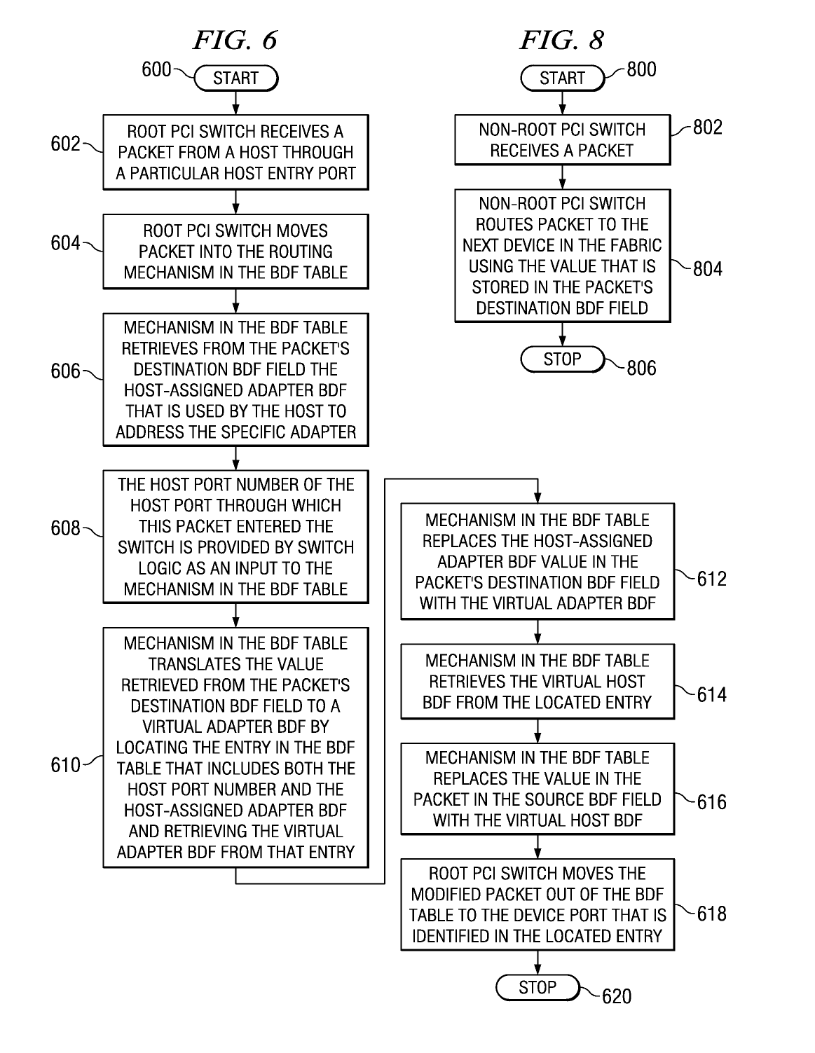

FIG. 6 is a high level flow chart that depicts a BDF translation and protection table receiving, from a particular host, a packet that is destined for a particular adapter and translating the host-assigned adapter BDF value that is included in the packet into a virtual adapter BDF value to use for further routing of the packet in accordance with the illustrative embodiment. The process starts as depicted by block 600 and thereafter passes to block 602 which illustrates the root PCI switch receiving a packet from a host through one of the switch's host entry ports. Next, block 604 depicts the root PCI switch moving the packet into the routing mechanism in the BDF table that is included in the root PCI switch.

The process then passes to block 606 which illustrates the routing mechanism in the BDF table retrieving the value that is stored in the packet's destination BDF field. At this point, the value is the host-assigned adapter BDF value that is used by the host to address the intended specific destination adapter. Thereafter, block 608 illustrates the host port number of the host port through which this packet entered the switch being provided by switch logic as in input to the mechanism in the BDF table. Next, block 610 depicts the mechanism in the BDF table translating the value retrieved from the packet's destination BDF field, i.e. the host-assigned adapter BDF, to a virtual adapter BDF by locating the entry in the BDF table that includes both the host-assigned adapter BDF and the host entry port number and then retrieving the virtual adapter BDF from the located entry. Thereafter, block 612 illustrates the mechanism in the BDF table replacing the host-assigned adapter BDF value that was originally stored in the packet's destination BDF field with the virtual adapter BDF value. Thus, the packet has been modified to now include the virtual adapter BDF in the packet's destination BDF field 406 instead of the host-assigned host BDF number.

Thereafter, block 614 illustrates the mechanism in the BDF table retrieving the virtual host BDF from the same BDF table entry. Block 616 depicts the mechanism in the BDF table replacing the value in the source BDF field, which was the host-assigned host BDF, with the virtual host BDF value.

Block 618, then, depicts the root PCI switch moving the modified packet out of the BDF table to the device port that is identified in the located entry. The process then terminates as depicted by block 620.

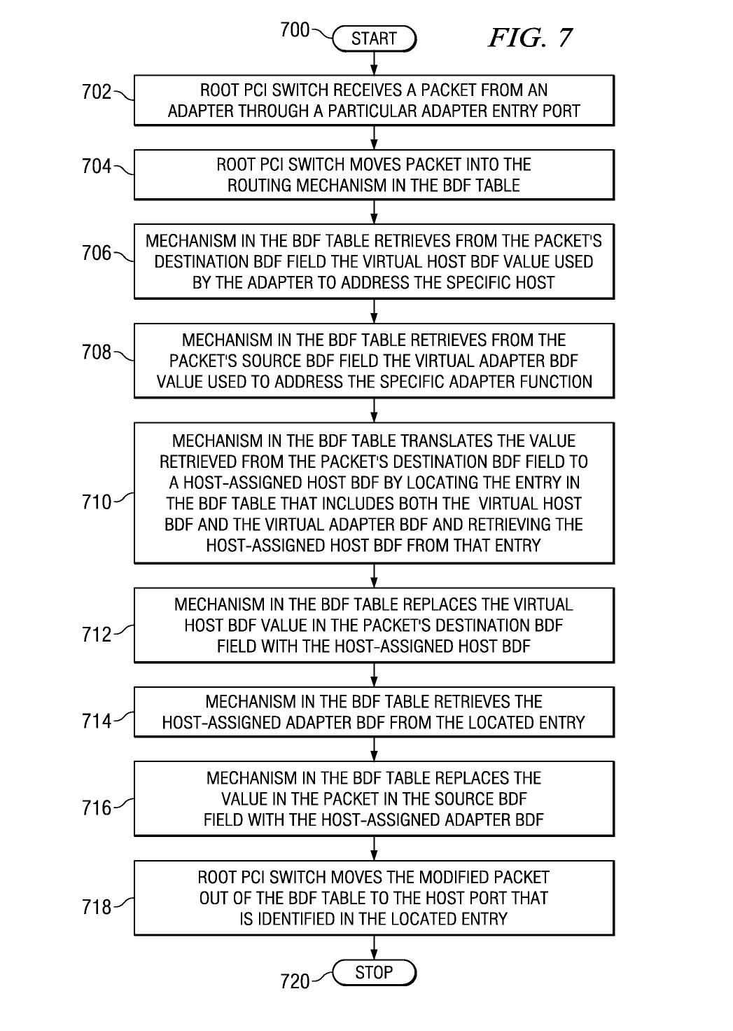

FIG. 7 is a high level flow chart that depicts a BDF translation and protection table receiving a packet from an adapter that is destined for a particular host, translating the included virtual adapter BDF value that is stored in the source BDF field to host-assigned adapter BDF value that the host expects to see, and translating the virtual host BDF value that is included in the destination BDF field into a host-assigned host BDF value to use for further routing of the packet in accordance with the illustrative embodiment.

The process starts as depicted by block 700 and thereafter passes to block 702 which illustrates the root PCI switch receiving a packet from an adapter through one of the switch's adapter entry ports. Next, block 704 depicts the root PCI switch moving the packet into the routing mechanism of the BDF table that is included in the root PCI switch.

The process then passes to block 706 which illustrates the mechanism in the BDF table retrieving the value that is stored in the packet's destination BDF field. At this point, the value is the virtual host BDF that is used by the adapter to address the specific host. Thereafter, block 708 illustrates the mechanism in the BDF table retrieving the value that is stored in the packet's source BDF field. At this point, the value is the virtual adapter BDF that is used by the adapter to address the specific host. Next, block 710 depicts the mechanism in the BDF table translating the value retrieved from the packet's destination BDF field to a host-assigned host BDF by locating the entry in the BDF table that includes the virtual host BDF and the virtual adapter BDF, which is this specific host-adapter pair, and then retrieving that entry. Thereafter, block 712 illustrates the mechanism in the BDF table replacing the virtual host BDF value that was originally stored in the destination BDF field with the host-assigned host BDF. Thus, the packet has been modified to now include the host-assigned host BDF in the packet's destination BDF field 406 instead of the particular host's virtual BDF value.

The process then passes to block 714 which illustrates the mechanism in the BDF table retrieving the host-assigned adapter BDF from the located entry. Next, block 716 depicts the mechanism in the BDF table replacing the value in the packet in the source BDF field with the host-assigned adapter BDF. Thus, the packet has also been modified to now include the host-assigned adapter BDF in the packet's source BDF field 402.

Block 718, then, depicts the root PCI switch moving the modified packet out of the BDF table to the host port that is identified in the located entry. The process then terminates as depicted by block 720.

FIG. 8 illustrates a high level flow chart that depicts a non-root PCI switch routing a packet using the value found in the destination BDF field in the packet in accordance with the illustrative embodiment of the present invention. The process starts as depicted by block 800 and thereafter passes to block 802 which illustrates a PCI switch receiving a packet. This PCI switch is not a root PCI switch. For example, this PCI switch may be PCI switch 327 or switch 331 depicted in FIG. 3. The packet is received from either another non-root PCI switch, a root PCI switch, or one of the adapters.

Thereafter, block 804 depicts the non-root PCI switch routing the packet to the next device in the fabric. The PCI switch routes the packet using the value that is stored in the destination BDF field. When the packet is received by a non-root PCI switch, the value in the destination BDF field is the virtual adapter BDF value. Thus, the packet is routed using only the virtual adapter BDF value. The packet may also be received from another non-root PCI switch where that non-root PCI switch received the packet from the root PCI switch. In this case, the value in the BDF field will also be the virtual adapter BDF value.

When a non-root PCI switch receives a packet from an adapter, the packet is also routed using the value in the destination BDF field, but in this case, the value will be the virtual host BDF value. Thus, this packet will be routed using the virtual host BDF value until that packet is received by the root PCI switch which will then replace the virtual host BDF value with the host-assigned host BDF value for further routing.

In all cases, the non-root PCI switch does not require any modification from the normal packet routing based on the destination BDF that is contained in the destination BDF field of the packet. The process then terminates as illustrated by block 806.

The invention can take the form of an entirely hardware embodiment, an entirely software embodiment or an embodiment containing both hardware and software elements. In a preferred embodiment, the invention is implemented in a combination of hardware and software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing environment for translating identifiers that are included in communication packets that are routed between a host and an I/O adapter using a PCI fabric to which said host and said I/O adapter are coupled, said method comprising:
each one of said identifiers identifying an intended recipient function that is included within either said host or said I/O adapter;
receiving a communications packet that includes a host-assigned identifier that identifies a particular function;
replacing said host-assigned identifier with a virtual identifier that identifies said particular function; and
routing said communications packet through said fabric using said virtual identifier.

2. The method according to claim 1, further comprising:
receiving said communications packet within a switch, said switch connected to a plurality of hosts; and
replacing, by said switch, said host-assigned identifier with said virtual identifier.

3. The method according to claim 2, further comprising:
routing, by said switch, said communications packet to a second switch that is included within said fabric; and
routing, by said second switch, said communications packet using said virtual identifier.

4. The method according to claim 1, further comprising:
a plurality of hosts that are coupled to a plurality of I/O adapters using said fabric;
assigning, by each one of said plurality of hosts, host-assigned identifiers for said plurality of I/O adapters, each one of said hosts assigning its own host-assigned identifiers; and
said host-assigned identifiers that are assigned by one of said plurality of hosts being the same as some of said host-assigned identifiers that are assigned by other ones of said plurality of hosts, wherein host-assigned identifiers are not unique identifiers.

5. The method according to claim 1, further comprising:
a plurality of hosts that are coupled to a plurality of I/O adapters using said fabric;
receiving a communications packet that includes a host-assigned identifier that identifies a particular function within one of said plurality of I/O adapters;
replacing said host-assigned identifier with one of a plurality of virtual identifiers that identifies said particular function; and
each one of said plurality of virtual identifiers being unique and identifying only one of a plurality of functions that are included within said plurality of I/O adapters.

6. The method according to claim 1, further comprising:
each one of said identifiers identifying an intended recipient function that is included within either said host or said I/O adapter.

7. The method according to claim 1, further comprising:
said identifier being a bus/device/function (BDF) number.

8. The method according to claim 1, further comprising:
receiving said communications packet through one of a plurality of ports in a switch that is included in said fabric; and
utilizing an identity of said one of said plurality of ports and said host-assigned identifier to determine said virtual identifier.

9. The method according to claim 1, further comprising:
connecting a root switch, which is included in said fabric, to said host; and
storing, in a table in said root switch, an association between host-assigned identifiers and virtual identifiers.

10. An apparatus in a data processing environment for translating identifiers that are included in communication packets that are routed between a host and an I/O adapter using a PCI fabric to which said host and said I/O adapter are coupled, said apparatus comprising:
each one of said identifiers identifying an intended recipient function that is included within either said host or said I/O adapter;
a translation apparatus receiving a communications packet that includes a host-assigned identifier that identifies a particular function;
said translation apparatus replacing said host-assigned identifier with a virtual identifier that identifies said particular function; and
said communications packet being routed through said fabric using said virtual identifier.

11. The apparatus according to claim 10, further comprising:
a switch receiving said communications packet, said switch connected to a plurality of hosts; and
said switch replacing said host-assigned identifier with said virtual identifier.

12. The apparatus according to claim 11, further comprising:
said switch routing said communications packet to a second switch that is included within said fabric; and
said second switch routing said communications packet using said virtual identifier.

13. The apparatus according to claim 10, further comprising:
a plurality of hosts that are coupled to a plurality of I/O adapters using said fabric;
each one of said plurality of hosts assigning host-assigned identifiers for said plurality of I/O adapters, each one of said hosts assigning its own host-assigned identifiers; and
host-assigned identifiers that are assigned by one of said plurality of hosts being the same as some of said host-assigned identifiers that are assigned by other ones of said plurality of hosts, wherein host-assigned identifiers are not unique identifiers.

14. The apparatus according to claim 10, further comprising:
a plurality of hosts that are coupled to a plurality of I/O adapters using said fabric;
said translation apparatus receiving a communications packet that includes a host-assigned identifier that identifies a particular function within one of said plurality of I/O adapters;
said translation apparatus replacing said host-assigned identifier with one of a plurality of virtual identifiers that identifies said particular function; and
each one of said plurality of virtual identifiers being unique and identifying only one of a plurality of functions that are included within said plurality of I/O adapters.

15. The apparatus according to claim 10, further comprising:
each one of said identifiers identifying an intended recipient function that is included within either said host or said I/O adapter.

16. The apparatus according to claim 10, further comprising:
said identifier being a bus/device/function (BDF) number.

17. The apparatus according to claim 10, further comprising:
a switch receiving said communications packet through one of a plurality of ports in said switch that is included in said fabric; and
said translation apparatus utilizing an identity of said one of said plurality of ports and said host-assigned identifier to determine said virtual identifier.

18. The apparatus according to claim 10, further comprising:
a root switch, which is included in said fabric, connected to said host; and
a table in said root switch storing an association between host-assigned identifiers and virtual identifiers.

19. A computer program product comprising:
a computer usable medium having computer usable program code for translating identifiers that are included in communication packets that are routed between a host and an I/O adapter using a PCI fabric to which said host and said I/O adapter are coupled, said computer program product code including:
each one of said identifiers identifying an intended recipient function that is included within either said host or said I/O adapter;
computer usable program code for receiving a communications packet that includes a host-assigned identifier that identifies a particular function;
computer usable program code for replacing said host-assigned identifier with a virtual identifier that identifies said particular function; and
computer usable program code for routing said communications packet through said fabric using said virtual identifier.

20. The computer program product according to claim 19, further comprising:
computer usable program code for receiving said communications packet through one of a plurality of ports in a switch that is included in said fabric; and
computer usable program code for utilizing an identity of said one of said plurality of ports and said host-assigned identifier to determine said virtual identifier.
